(19) United States
(12) Patent Application Publication
(10) Pub. No.: US 2013/0144968 A1
(43) Pub. Date: Jun. 6, 2013

(54) SHARING FILES ON A WIRELESS DEVICE

(71) Applicant: Adam L. Berger, Pittsburgh, PA (US)

(72) Inventor: Adam L. Berger, Pittsburgh, PA (US)

(21) Appl. No.: 13/310,331

(22) Filed: Dec. 2, 2011

(51) Int. Cl. G06F 15/16; H04W 8/00

(52) U.S. Cl. 709/217

(57) ABSTRACT

Among other features, one aspect of the subject matter described in this specification can be implemented in methods that include, from a wireless handheld device, automatically transferring to another location a media object captured on the wireless handheld device without requiring a user of the wireless handheld device to initiate the transfer of the media object, and regulating the transfer in response to information about a condition of the wireless handheld device.

This description relates to sharing files on a wireless device.

### BACKGROUND

A media object (such as a video, image, song, or other multimedia object), stored on a server and designated for later playing on a mobile device can be delivered to the mobile device proactively or reactively. In proactive delivery, the media object is delivered to and stored on the mobile device ahead of when the user attempts to access it. In reactive delivery, the media object is held on the server until it is requested by user, and then delivered to the mobile device and consumed as it is being received.

### SUMMARY

In general, one aspect can be implemented in methods that include, from a wireless handheld device, automatically transferring to another location a media object captured on the wireless handheld device without requiring a user of the wireless handheld device to initiate the transfer of the media object, and regulating the transfer in response to information about a condition of the wireless handheld device.

Implementations may include one or more of the following features. The condition comprises a charge level of a battery of the wireless handheld device. The condition comprises a quality of a network connection which carries the transfer of the media object. The condition comprises available storage space on the wireless handheld device. Regulating the transfer comprises changing a speed of the transfer. Regulating the transfer comprises determining a start time of the transfer based on the conditions. Regulating the transfer comprises pausing the transfer at a first time and resuming the transfer at a second time after the first time. The information about the condition is acquired by monitoring the condition at the wireless handheld device. The media object comprises a video. The media object comprises an image. The other location comprises a storage facility distributed on a network. The other location comprises a web site storing videos and offering the videos for viewing. The handheld wireless device comprises a mobile phone. The handheld wireless device comprises a tablet computer. Settings are accepted from the user which control the transfer of the media object. At the wireless handheld device, an indication of one or more recipients for the media object is accepted from the user. The method includes displaying on the handheld wireless device information about recipients of the media object. The method includes accepting from the user an indication of names to be removed from a list of names of the recipients. The method includes displaying information about activities of at least some recipients of the media object, the activities pertaining to the media object. The method includes, at the wireless handheld device, accepting from the user an indication of no restrictions on who may receive the media object. The method includes transferring the media object from the wireless handheld device based on a condition of the wireless handheld device. Conditions of the wireless handheld device include remaining battery life of the wireless handheld device. Conditions of the wireless handheld device include a communications network available to the wireless handheld device.

Another aspect of the subject matter described in this specification can be implemented in methods that include, at a wireless handheld device, automatically receiving from another location a media object captured on another wireless handheld device without requiring a user of the wireless handheld device to initiate the receipt of the media object, and regulating the receipt in response to information about a condition of the wireless handheld device.

Implementations may include one or more of the following features. The condition comprises a charge level of a battery of the wireless handheld device. The condition comprises a quality of a network connection which carries the media object undergoing receipt. The condition comprises available storage space on the wireless handheld device. Regulating the receipt comprises changing a speed of the receipt. Regulating the receipt comprises determining a start time of the receipt based on the conditions. Regulating the receipt comprises pausing the receipt at a first time and resuming the receipt at a second time after the first time. The information about the condition is acquired by monitoring the condition at the wireless handheld device. The media object comprises a video. The media object comprises an image. The other location comprises a storage facility distributed on a network. The other location comprises a web site storing videos and offering the videos for viewing. The handheld wireless device comprises a mobile phone. The handheld wireless device comprises a tablet computer. The method includes, at the wireless handheld device, accepting settings from the user prior to the receipt. The user is identified as a recipient of the media object by a user of another handheld wireless device. The media object has been designated as having no restrictions on who may receive the media object. The method includes downloading the media object to the wireless handheld device at a time based on a condition of the wireless handheld device. Conditions of the wireless handheld device comprise remaining battery life of the wireless handheld device. Conditions of the wireless handheld device comprise a communications network available to the wireless handheld device.

A further aspect can be implemented in methods comprising, on behalf of a user of a wireless handheld device, maintaining settings to control automatic uploading of videos captured at the device and automatic downloading of the videos to other target wireless handheld devices.

Implementations may include one or more of the following features. The control settings identify the target wireless handheld devices. The control settings specify conditions under which the video is to be uploaded.

Another aspect of the subject matter described in this specification can be implemented in methods that include, upon generation of a video by a wireless handheld device, prompting a user of the handheld device to identify recipients for the video, and through a network, communicating information about the video to the identified recipients, the information including data usable to access the video at other wireless handheld devices each possessed by one of the respective identified recipients.

Implementations may include one or more of the following features. The method includes receiving from the user of the handheld device an indication of the extent to which the information about the video may be transmitted to entities other than the identified recipients. The method includes prompting a user of the handheld device for identities of recipients of the video comprises providing identification information about possible recipients to the user, and subsequently receiving from the user of the handheld device an indication that the information about the video is to be transmitted to all of the possible recipients. The method includes subsequently communicating information indicating that the access to the video be disabled at the other wireless handheld devices.

A further aspect of the subject matter described in this specification can be implemented in methods on a first wireless handheld device, receiving from a user of a second wireless handheld device information describing a video stored on a remote server, the information usable to access the video, and absent user input within a user interface, displaying a graphical element representing the video, the graphical element displayed among other graphical elements representing other videos.

Implementations may include one or more of the following features. The method includes receiving authorization information may be received from the user of the second wireless handheld device. The graphical elements are displayed in a chronological order of receipt of the videos. The graphical element is displayed among other graphical elements representing other videos received from other users. The graphical element comprises an identification of the user of the second wireless handheld device. The user of the second wireless handheld device is designated on a list of users of wireless handheld devices authorized by a user of the wireless handheld device to deliver videos to the first wireless handheld device. The method includes receiving, from the user of the second wireless handheld device, a request to add the user of the second wireless handheld device to the list of users of wireless handheld devices. The method includes receiving, from the user of the first wireless handheld device, a request to add the user of the second wireless handheld device to the list of users of wireless handheld devices. The method includes deleting the video from the first wireless handheld device based on a chronological age of the video relative to other videos received at the first wireless handheld device. The method includes deleting the video from the first wireless handheld device subsequent to an indication by a user of the first wireless handheld device to view the video. The method includes deleting the video from the first wireless handheld device based on a limit of data storage allocated to videos on the first wireless handheld device.

A further aspect includes, on a first wireless handheld device, displaying a list of users of wireless handheld devices who publically share at least one video, the list received from a storage facility distributed on a network, receiving, on a user interface of the first wireless handheld device, from a user of the first wireless handheld device, an indication to add at least one of the users of wireless handheld devices to a list of users of wireless handheld devices authorized to deliver videos to the first wireless handheld device.

In another aspect of the subject matter described in this specification can be implemented in methods that include, on a wireless handheld device, receiving information describing a video stored on a remote server, the information usable to access the video, receiving, from a user of the handheld device, information identifying recipients of the video, and through a network, communicating the information usable to access the video to the identified recipients.

Implementations may include one or more of the following features. Communicating the information usable to access the video to the identified recipients comprises communicating information identifying the user of the handheld device to the identified recipients.

Additionally, in another aspect, subject matter described in this specification can include a handheld wireless device comprising a user interface enabling a user of the handheld wireless device to record a video using the handheld wireless device, designate one or more users of other wireless devices who are to be recipients of the video, and define conditions for uploading of the video for delivery to the recipients.

Implementations may include one or more of the following features. The user interface enables a user to designate a video for unsharing, wherein unsharing comprises sending a directive to the devices of the recipients which causes those devices to remove data related to the video from storage associated with the devices of the recipients. The user interface displays a plurality of graphical elements, each representing a video available for playback.

One aspect of the subject matter described in this specification can be implemented in methods that include, at a storage facility distributed on a network, receiving, from a wireless handheld device, a media object captured on the wireless handheld device, without requiring a user of the device to initiate delivery of the media object and without requiring the user to control the delivery of the media object.

Implementations may include one or more of the following features. The method includes sending the media object to another wireless handheld device, without requiring a user of the other wireless handheld device to initiate receipt of the media object and without requiring the user of the other wireless handheld device to control the receipt of the media object.

An additional aspect of the subject matter described in this specification can be implemented in methods that include, at a storage facility distributed on a network, sending, to a first wireless handheld device, a media object captured on a second wireless handheld device, without requiring a user of the first wireless handheld device to initiate receipt of the media object and without requiring the user to control the receipt of the media object

An additional aspect of the subject matter described in this specification can be implemented in methods that include automatically providing media objects to a wireless handheld device without requiring a user of the wireless handheld device to initiate or to control receipt of the media objects, the number of received media objects and quantity of received media object data being limited within a time period, wherein a first number of media objects and a first quantity of media object data are automatically provided within the time period for free, and a second number of media objects and a second quantity of media object data are automatically provided within the time period at a monthly rate of payment.

Implementations may include one or more of the following features. The method includes receiving payment information from the wireless handheld device and providing a number of media objects greater than the first number of media objects to the wireless handheld device within the time period. The method includes receiving payment information from the wireless handheld device and providing a quantity of media object data greater than the first quantity of media object data to the wireless handheld device within the time period.

A further aspect of the subject matter described in this specification can be implemented in methods accepting media objects from a wireless handheld device without requiring a user of the wireless handheld device to initiate or to control transfer of the media objects, the quantity of media object data of each media object being limited within a time period, wherein media objects having a first quantity of media object data are accepted within the time period for free, objects having a second quantity of media object data are accepted within the time period at a monthly rate of payment, the second quantity being larger than the first quantity.

Implementations may include one or more of the following features. The first quantity of media object data comprises a first length of time of the corresponding media object and the second quantity of media object data comprises a second length of time of the corresponding media object.

A further aspect of the subject matter described in this specification can be implemented in methods a target handheld wireless device, automatically receiving, through a server from a source handheld wireless device, a video file that was captured by a camera at the source handheld wireless device, the receipt of the video file at the target handheld wireless device occurring without a user of the target device initiating the receipt, the identity of the target handheld device having been specified by a user of the source handheld device.

These and other features and aspects, and combinations may also be expressed as methods, business methods, apparatus, systems, program products, databases, means for performing functions, and in other ways.

Other advantages and features will become apparent from the following description and from the claims.

### DESCRIPTION

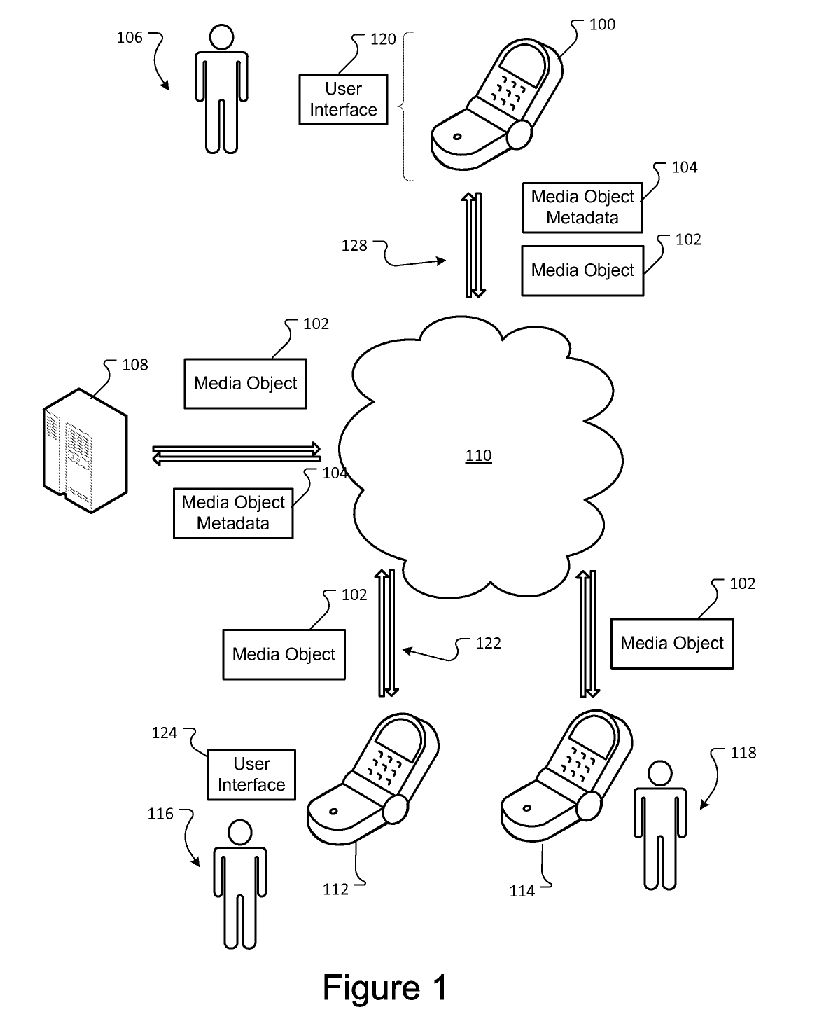

FIG. 1 is a block diagram.

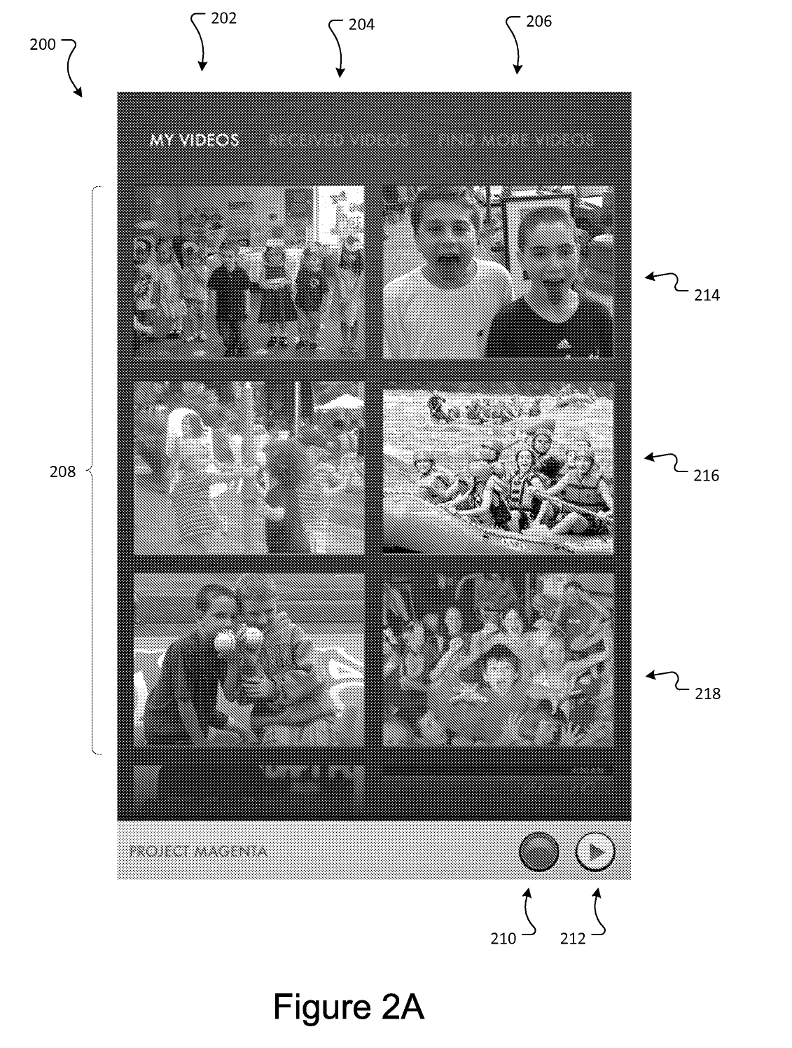

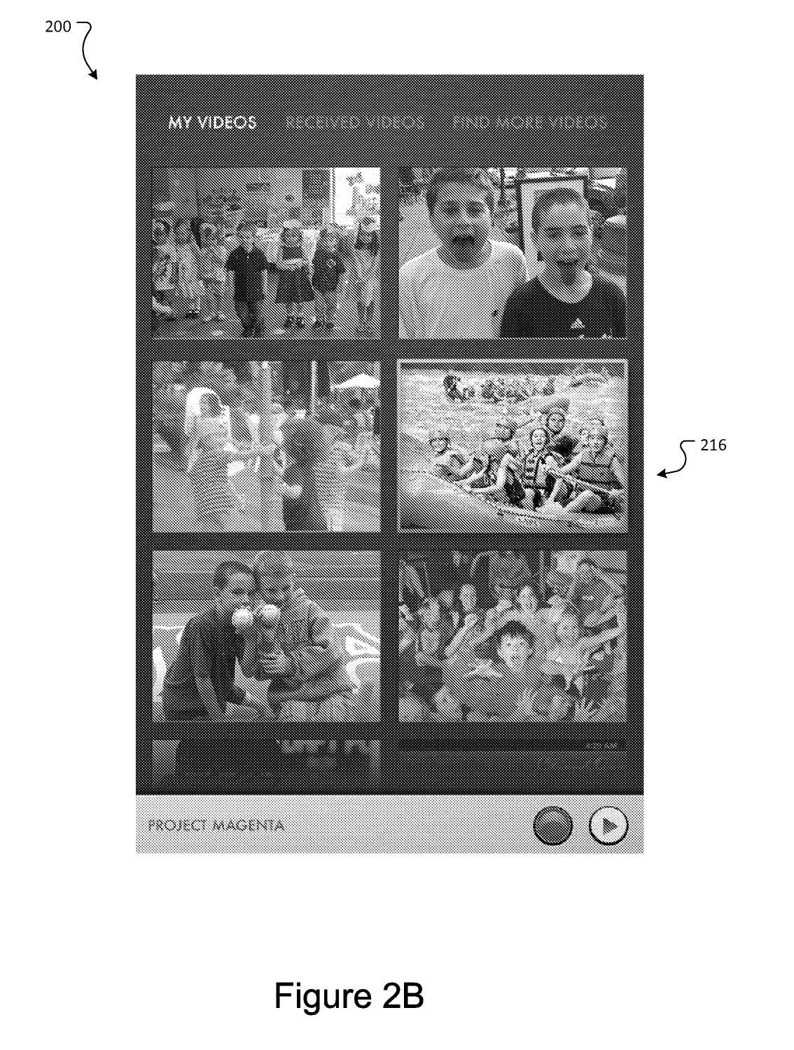

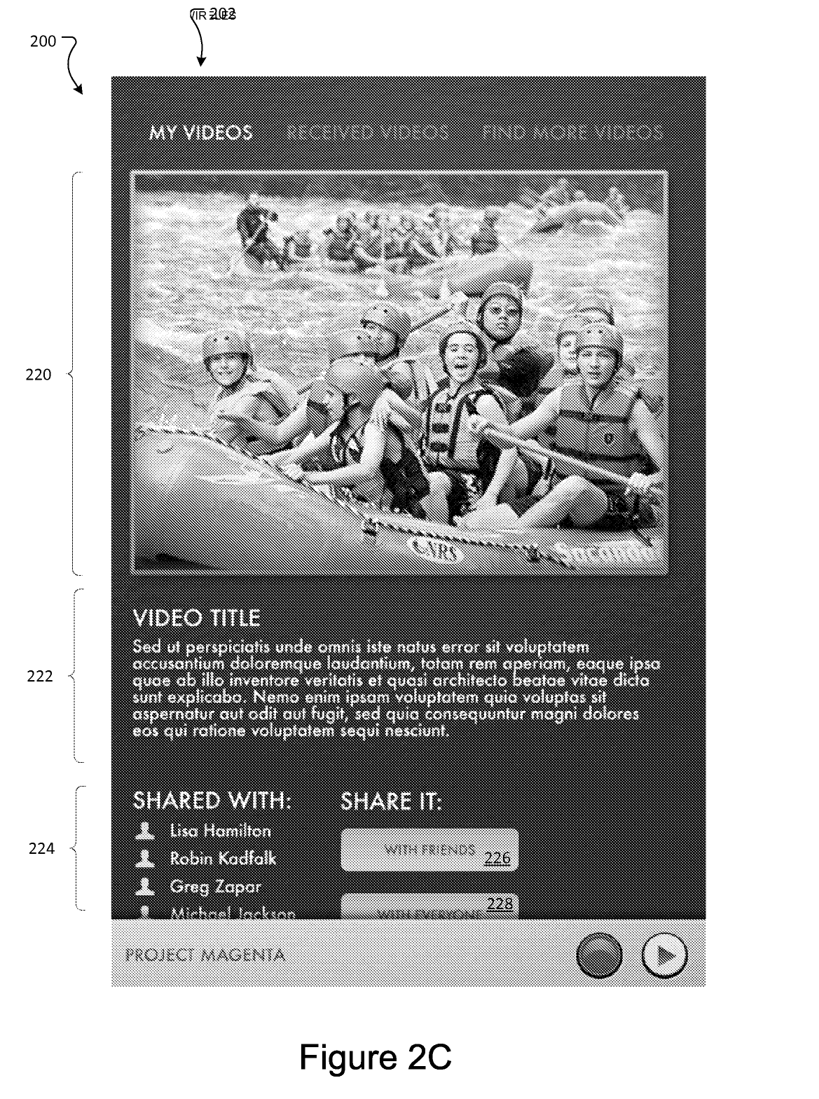

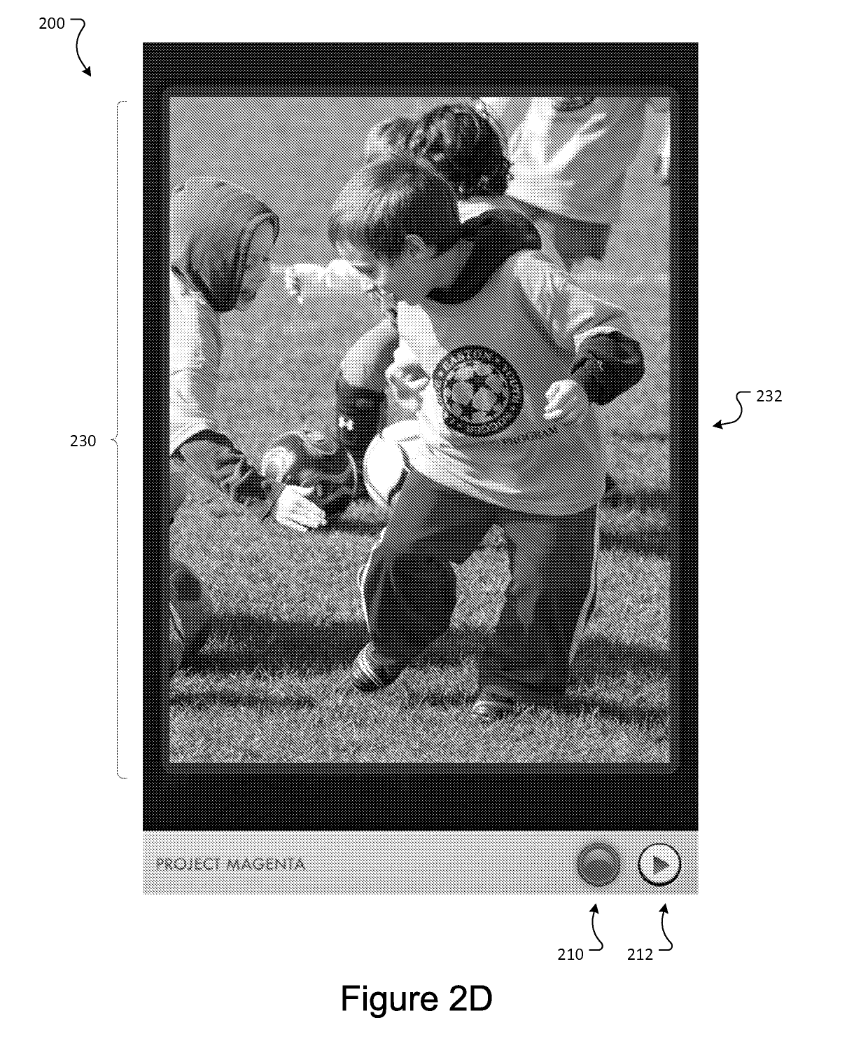

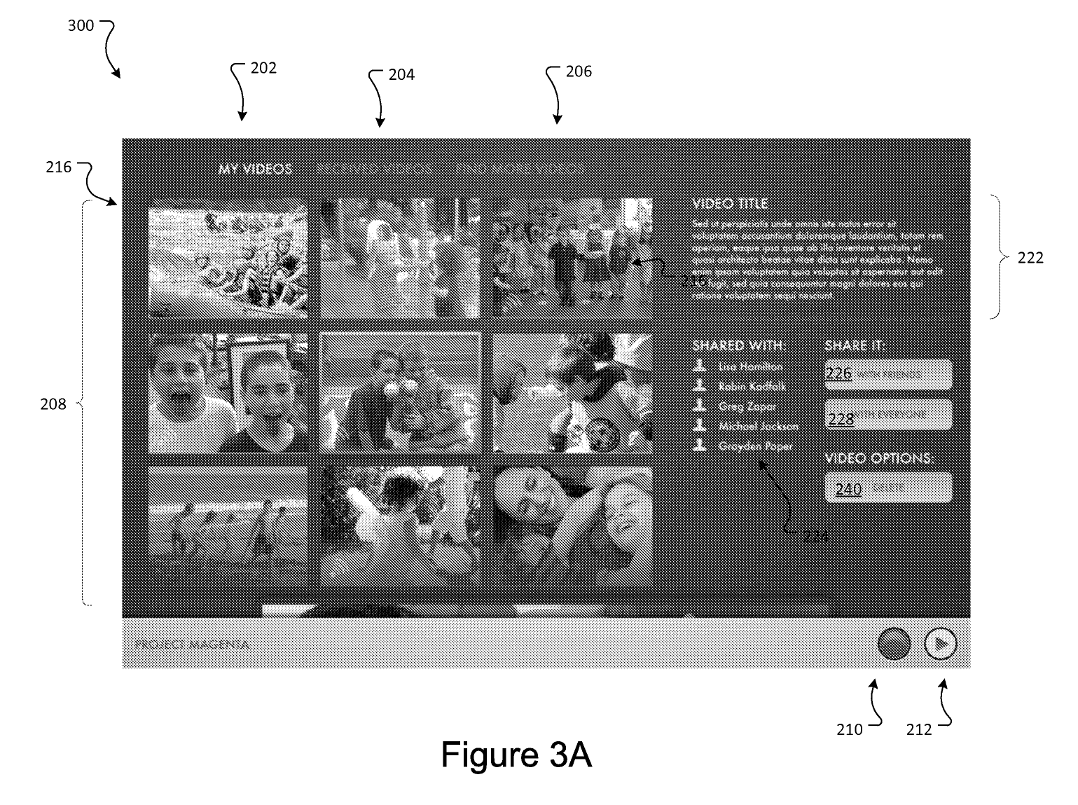

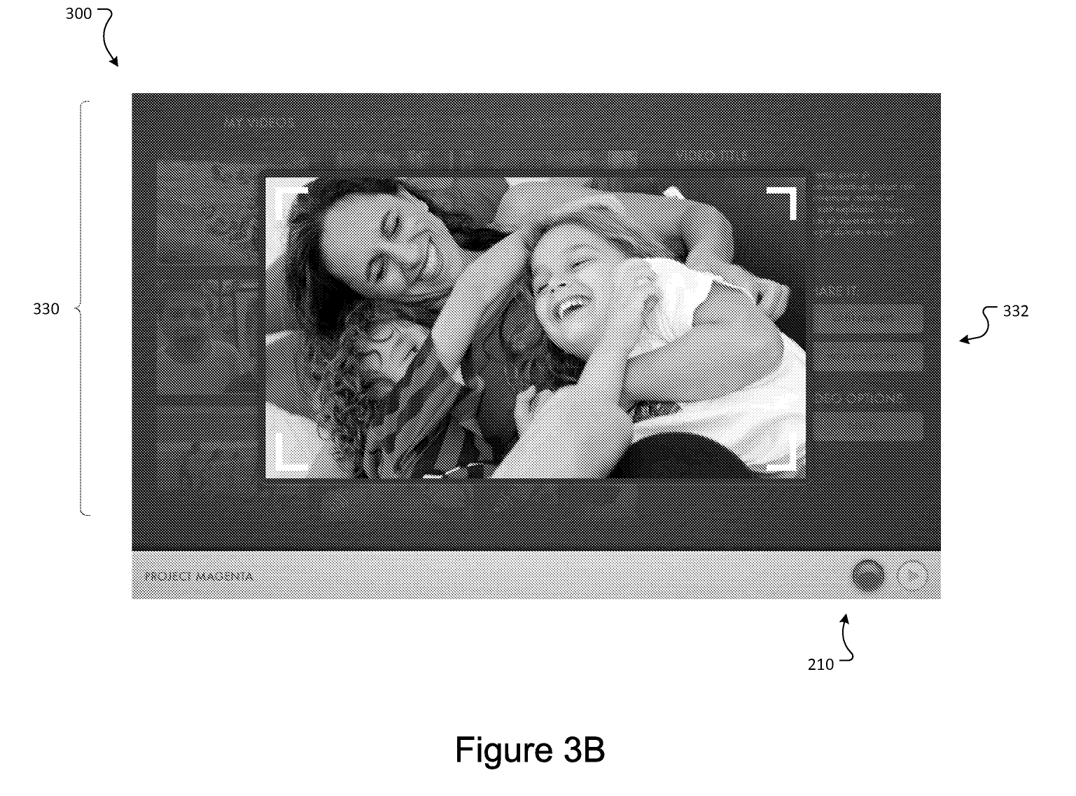

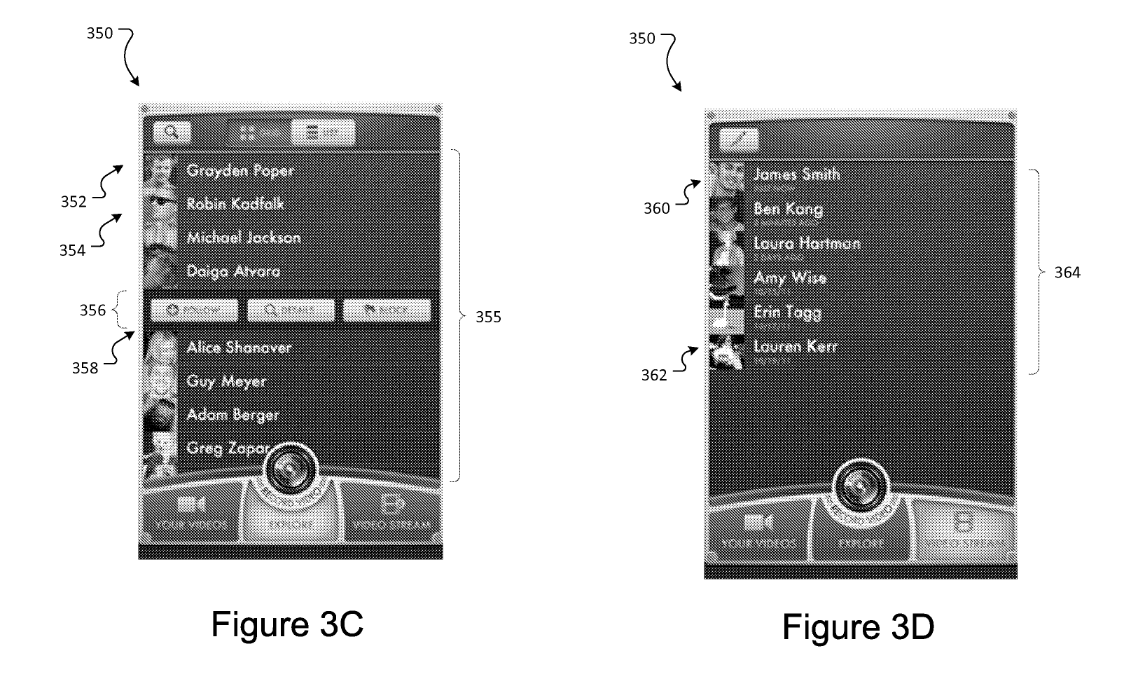

FIGS. 2A-2D and 3A-3D show a user interface.

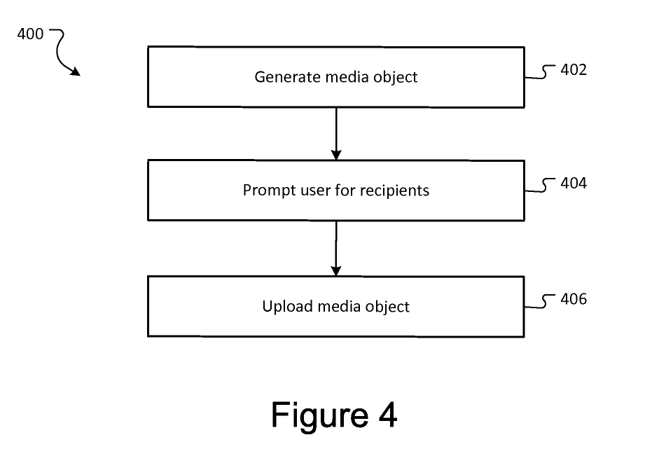

FIG. 4 is a flowchart.

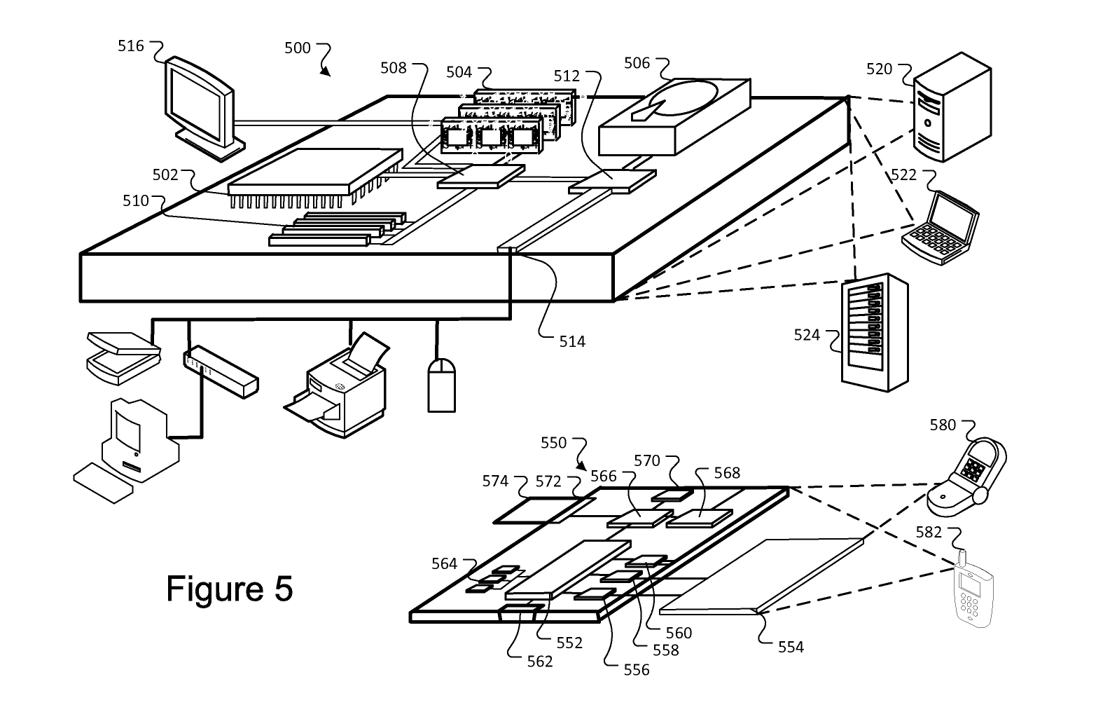

FIG. 5 is a block diagram.

Referring to FIG. 1, a mobile device 100 can transmit a media object 102 (for example, a video or image) to other entities by way of a network 110. For example, the mobile device 100 can transmit the media object 102 to a media repository 108 available on the network 110. The media object 102 can then be received by other mobile devices 112, 114. The transmission and receipt of the media object 102 can be performed in the background, for example, without requiring users 106, 116, 118 of the devices to initiate or to control the transmission or receipt.

Here, “transmission” or “upload” refers in the broadest sense to any kind of transferring, for example, of a media object from a mobile device to another entity. “Receipt” or “download” refers in the broadest sense to any kind of transferring of a media object to a mobile device from another entity. These actions can all be generically referred to as “transfer” or “delivery.” When these kinds of actions occur, they may be initiated by the mobile device, or they may not be.

In some implementations of the technique described here, a user 106 of a mobile device 100 never needs to take any action to deliver new media objects 102 to the media repository 108. For example, the user 106 never needs to issue a command to the mobile device 100 to deliver the media objects 102. Instead, the action of delivering the media objects 102 to the media repository occurs automatically in response to some other action of the user 106, for example, the action of the user 106 of creating the media object 102. In some implementations, a user 116 of another mobile device 114 need not query for new media objects 102 on the media repository 108 or to take any other action to identify a new media object of interest, nor to fetch the media objects 102 from the media repository 108. In some cases, delivery 122 of the new media objects 102 (for example, over a network) can occur automatically and without user action or knowledge. There is no need, for example, to press any key on the mobile device 114 or to launch an executable application on the mobile device 114 or to attach a cable to the device to cause the file delivery to occur. In general, a user 106 of the mobile device 100 can generate a media object 102 and indicate that the media object 102 is to be shared with other users; no further action is required. In some cases, the user would not even need to indicate that a particular media object is to be shared in order for the delivery to occur. The user can set up preferences about delivery prior to the time when a media object is generated.

In our use of the term mobile device, we include (without limitation and in the broadest possible sense), for example, cellular phones, smart phones, tablet computers, personal digital assistants, in-vehicle entertainment systems, notebook computers, and any other device that is portable and can communicate through an available (typically wireless) communication channel, such as a cellular network or a local wireless network such as WiFi.

In our use of the term media object, we include (without limitation and in the broadest possible sense), for example, music, images, videos, cartoons, advertisements, text documents, other multimedia objects, and any other object that can be presented to, played for, or performed for a user of the device using audio, video, display, or other technologies. In our use of the term play and the term present, we include (without limitation) performing, playing audibly or visually or both, displaying, or in any way presenting to a user's senses.

A media repository 108 is any system that makes media content such as media objects available on a network. In some examples, the media repository could be a server accessible on the network 110, or it could be a collection of servers that are co-located or distributed, or it could be a portion of a server's functionality, or a server or servers accessible as a web site, or a collection of web sites, or it could be any combination of these things (e.g., a web site hosted by one or more servers).

In some implementations, the media repository 108 could be a storage facility distributed on the network 110. In some examples, the media repository 108 could be an amalgamation of multiple computer systems (e.g., hundreds or thousands), some of which may be at physical locations many miles (e.g., hundreds or thousands) apart from each other. A storage facility distributed on the network 110 in this way may appear to a mobile device 100 as a single facility. For example, the media repository 108 could have a single interface (e.g., a single point of entry such as a single address) to entities outside of the individual components distributed on the network. The media repository 108 could operate under any set of protocols used to transfer data using a network. The media repository 108 could be a specialized media repository for a particular kind of media. For example, the media repository 108 could be a web site storing videos and offering the videos for viewing.

The mobile device 100 may connect to the network 110 using any of a variety of mechanisms, for example, GPRS/EDGE, CDMA/EVDO, WiFi, Bluetooth, or USB cable tethered to a host computer. The mobile device 100 may have access to more than one network connection. For example, at one moment, WiFi and EDGE may be available; a few minutes later, only EDGE may be available.

In use, the user 106 of a mobile device 100 creates a media object 102 on the mobile device 100. For example, the user 106 can record a video (or an image or a stream or set of images) using a built-in camera of the mobile device 100. In the course of recording the media object, and the mobile device 100 can generate a media object 102 in the form of a video file, for example. We sometimes refer to this process of recording media and then generating data representing the media simply as “recording” or “capturing.”

In some implementations, the media object 102 is not generated on the mobile device 100. For example, the media object 102 could be downloaded from another entity such as a web site, a media repository, or another entity that stores media objects. The media object 102 that has been generated or downloaded can be immediately transmitted (e.g., transmitted as soon as possible based on conditions of the mobile device) to the media repository 108 subsequent to generation or downloading, or the media object 102 can be transmitted after a period of time. In some implementations, the user 106 does not need to take any action to cause the media object 102 to be transmitted, nor does the user 106 need to take any steps to control the transmission of the media object 102. In some implementations, the user 106 may take actions in conjunction with the delivery, including confirming that the media object 102 should be delivered. In some implementations, the user 106 may indicate recipients for the media object 102. In some implementations, the user 106 may establish settings in advance of the transmission of the media object 102. The settings could take any form and could indicate any information relevant to transfer of media objects. For example, the settings could be settings for under what conditions the media object 102 should be transmitted or to whom the media object 102 should be designated for delivery. Settings could apply to a particular media object 102 or any media object. Once the media object 102 has been delivered to the media repository 108, the media object 102 is available for delivery to other mobile devices 112, 114.

A media object 102 stored by the media repository 108 can be delivered to the other (and received by) one or more other mobile devices 112, 114 without any action being taken by the users 116, 118 of the respective mobile devices. Generally, this type of delivery, in which a user does not need to make a request or take an action to receive an item from another entity over a network, but instead the other entity proactively (e.g., autonomously) transmits the item to the user, is sometimes called “push” delivery.

In some implementations, the users 116, 118 can control the delivery of the media object 102 to their respective mobile devices 112, 114. In some implementations, the users 116, 118 may establish settings in advance of the receipt of the media object 102. The settings could take any form and could indicate any information relevant to transfer of media objects. For example, the settings could be a set of conditions under which the media object 102 should be downloaded to the recipient device. Settings could apply to a particular media object 102 or any media object. In some implementations, the media repository 108 can determine a time at which to deliver the media object 102. In some implementations, the other mobile devices 112, 114 can automatically query the media repository 108 for new media objects 102, without the user of the other mobile device initiating or involved in the querying. The media object 102 will appear automatically, for example, on mobile devices 112, 114 and will then be available for playback by the users 116, 118, for example, for playback at a time chosen by the respective users. In some implementations, the media object 102 can play back on a mobile device 114 automatically once it is received at the mobile device 114. For example, the user 106 who uploads the media object 102 may designate the media object 102 for immediate playback once the media object 102 is received by other mobile devices. In some implementations, the media object 102 could be transmitted from the mobile device 100 directly to another mobile device 112, 114, rather than transmitted to the media repository 108.

Generally, any of the mobile devices 100, 112, 114 is capable of transferring media objects 102, e.g., transmitting and receiving media objects 102. In some implementations, any of the mobile devices 100, 112, 114 could initiate the delivery of a media object 102 to any of the other mobile devices 100, 112, 114. In some implementations, any of the mobile devices 100, 112, 114 could receive a media object 102 delivered by any of the other mobile devices 100, 112, 114.

In some examples, information about the media object 102 is delivered to the other mobile devices 112, 114. The information about the media object 102 may be usable to access the media object 102. In some examples, the delivery of information about the media object 102 does not include delivery of the media object 102. In some examples, the information about the media object 102 is data representing the media object 102.

The user 106 of the mobile device 100 from which the media object 102 originates can indicate which users 116, 118 the user 106 wishes the media object 102 to be delivered to. In some examples, when the user 106 captures video or otherwise generates a media object 102, the user 106 can use a user interface 120 of the mobile device 100 to indicate which users 116, 118 the media object 102 may be delivered to. We sometimes refer to this technique as “sharing” the media object 102 with recipients, e.g., the other users 116, 118.

In some examples, the user 106 can indicate that the media object 102 may be delivered to any user, i.e., indicate that the media object 102 is for public consumption and may be delivered to anybody. We sometimes refer to this technique as “sharing” the media object 102 with the public or “publicly sharing” the media object 102. In some examples, when the mobile device 100 transmits the media object 102 to the media repository 108, the mobile device 100 also transmits media object metadata 104 that describes the media object 102. For example, the media object metadata 104 can include information about which users 116, 118 the media object 102 may be delivered to. In some examples, the media object metadata 104 can include information such as when the media object 102 was created, a geographical location at which the media object 102 was created, a data format of the media object 102, security data related to the media object 102 such as a fingerprint generated using a hash function applied to the media object 102 or other security data.

Although the user 106 of the mobile device 100 from which the media object 102 originates does not need to initiate or control the delivery of the media object 102 to other entities, in some examples, the user 106 can specify upload settings for the media object 102 prior to generating the media object, or prior to the upload of the generated media object 102 to the media repository 108. In some examples, the user 106 can specify upload settings for the media object 102 during the upload of the media object 102 to the media repository 108.

In some implementations, the user 106 can indicate conditions under which the mobile device 100 can transmit a media object 102. In some examples, the user 106 may indicate that the mobile device 100 can transmit a media object 102 if the battery life of a battery of the mobile device 100 is at or above a certain threshold, e.g., at or above 75% of full capacity. In some examples, the user 106 may indicate a network connection to use for transmitting media objects 102. For example, the user 106 may indicate that the mobile device 100 shall only transmit a media object 102 if the mobile device 100 is connected to a higher-speed network connection (such as WiFi) as opposed to a lower-speed network connection (such as a cellular network). In some examples, the user 106 may indicate a maximum amount of media object data that the mobile device 100 may transmit in a given time period. For example, the user 106 may indicate that no more than fifty megabytes of media object data shall be transmitted by the mobile device 100 in a particular month, for example, to avoid exceeding a data limit of a cellular service plan to which the user 106 subscribes.

Further, although a user 116 of a mobile device 112 to which the media object 102 is delivered does not need to initiate or control the receipt of the media object 102, in some examples, the user 116 can specify download settings for the media object 102 prior to the download of the media object 102 to the mobile device 112 and, in some examples, the user 116 can specify download settings for the media object 102 during the download of the media object 102 from the media repository 108 to the mobile device 112.

In some implementations, the user 116 can indicate conditions under which the mobile device 112 can receive a media object 102. In some examples, the user 116 may indicate that the mobile device 112 can receive a media object 102 if the battery life of a battery of the mobile device 112 is at or above a certain threshold, e.g., at or above 75% of full capacity. In some examples, the user 116 may indicate a network connection to use for receiving media objects 102. For example, the user 116 may indicate that the mobile device 100 shall only download a media object 102 if the mobile device 112 is connected to a higher-speed network connection (such as WiFi) as opposed to a lower-speed network connection (such as a cellular network). In some examples, the user 116 may indicate a maximum amount of media object data that the mobile device 112 may receive in a given time period. For example, the user 116 may indicate that no more than fifty megabytes of media object data shall be received by the mobile device 112 in a particular month, for example, to avoid exceeding a data limit of a cellular service plan to which the user 116 subscribes. In some examples, the user 116 may indicate a maximum amount of media object data that the mobile device 112 may store. For example, the user 116 may indicate that no more than two hundred megabytes of media object data shall be stored by the mobile device 112, for example, to avoid reaching a storage capacity of internal data storage of the mobile device 112. The time at which a media object 102 is transmitted from the mobile device 100 to the media repository 108 may vary based on conditions present at the mobile device 100. In some examples, the conditions may include battery life of the mobile device 100. For example, if the mobile device 100 is powered by a battery, transmission 128 of the media object 102 may consume a large amount of battery power. The mobile device 100 can be configured to delay transmission 128 of the media object 102 if the battery power is below a threshold level (e.g., until the battery power has returned to a threshold level). Thus, transmission 128 of the media object 102 is less likely to deplete the battery power of the mobile device 100.

In some examples, the conditions may include a network connection available at the mobile device 100. For example, the mobile device 100 may have access to more than one type of network connection, and the network connections may vary in available bandwidth. Transmission 128 of the media object 102 may consume a larger amount of time if the mobile device 100 is connected to the network 110 using a slower network connection, but may consume a smaller amount of time if the mobile device 100 is connected to the network 110 using a faster network connection. The mobile device 100 can be configured to delay transmission 128 of the media object 102 if the mobile device 100 is connected using the slower network connection (e.g., until the mobile device 100 is connected using the faster network connection). Thus, transmission 128 of the media object 102 is less likely to take a large amount of time. Use of the faster network can also improve battery life, because the amount of time during which the media object 102 is undergoing transmission can correlate to usage of stored battery power. The mobile device 100 can be configured in these ways by the user 106 or by another entity (e.g., a system administrator for multiple mobile devices) that configures operation of the mobile device 100. In some implementations, the mobile device 100 can acquire information about its conditions by monitoring the conditions, such as network connections and battery life. For example, the mobile device 100 may have an internal process, such as an executable program, that monitors the conditions of the mobile device 100 and makes this information available to other applications operating on the mobile device 100.

In some examples, a mobile device 100 can begin uploading (or downloading) a media object 102, and then the conditions of the mobile device 100 will change during the time the media object 102 is being uploaded. For example, a battery level of the mobile device 100 may drop below a threshold, or the mobile device 100 may lose access to a particular network connection, or another condition of the mobile device 100 may change. The mobile device 100 can pause the upload (or download) of the media object 102 in response to this changed condition, and later resume the upload (or download) of the media object 102 when the conditions have returned to a state in which the media object 102 may be uploaded (or downloaded), e.g., according to settings specified by a user of the mobile device 100.

In some examples, the mobile device 100 can change the speed of the transfer of a media object 102 in response to a change in the conditions of the mobile device 100. For example, the mobile device 100 can reduce the speed of the upload (or download) of the media object 102 in response to a changed condition, and later increase the speed of the upload (or download) of the media object 102 when the conditions have returned to a state in which the media object 102 may be uploaded (or downloaded) at the original speed, e.g., according to settings specified by a user of the mobile device 100. For example, decreasing the speed of the transfer may reduce the amount of battery power used for the transfer.

In some examples, a user 116 is notified when a media object 102 has been delivered to (received by) his mobile device 112. For example, a user interface 124 of the mobile device 112 can display the notification. In some examples, a user 116 can be notified when a media object 102 has been delivered to his mobile device 112 in a wide variety of ways, and at a wide variety of times. For example, the notification can be presented audibly or visually or both, through a display screen, speakers, earphones, vibration, or any combination of them. The notification can be generated at a server (e.g., a server of the media repository 108), delivered to the mobile device 112, and used by the mobile device 112 as is (or with modification) in the presentation of the notification to the user. The notification can be presented to the user in any form and through any presentation medium, for example, by email or a text message, on screen, embedded in other objects being presented, or in other ways. A notification could also be displayed on the user interface 120 of the mobile device 100 of a user 106 who has generated a media object 102, e.g., once the media object 102 has been uploaded.

In some examples, a user 116 who has received a media object 102 on his mobile device 112 can designate the media object 102 for access (e.g., viewing or playback) by another user 118 or more than one other user or anybody. We sometimes refer to this technique as “re-sharing” the media object 102. In some implementations, the user 116 can indicate on his mobile device 112 (e.g., on a user interface 124) that the media object 102 is to be accessible by another user 118. The mobile device 112 then communicates this indication to the media repository 108. In turn, the media repository 108 can transmit the media object 102 to a mobile device 114 in possession of the other user 118. The other use can then view, play, or otherwise access the media object 102, in the same way as if the user 106 who created the media object 102 and/or uploaded the media object 102 to the media repository 108 had designated that the media object 102 may be accessed by the other user 118. In some implementations, when the first user 116 indicates that the media object 102 may be accessed by the second user 118, then the mobile device 112 of the first user 116 transmits the media object 102 directly to the mobile device 114 of the second user 118 (for example, the mobile device 112 may transmit data representing the media object 102 directly to the mobile device 114 rather than relying on another entity such as the media repository 108).

In some implementations, the user 106 who created the media object 102 and/or uploaded the media object 102 to the media repository 108 designates who may receive the media object 102. For example, the user 106 may indicate that only certain users may receive the media object 102. If the user 106 has indicated that one user 116 may receive the media object 102, but not that another user 118 may receive the media object, then the user 116 who receives the media object 102 may not designate the other user 118 to receive the media object 102. For example, if the user 116 attempts to designate the other user 118 to receive the media object 102, then the user interface 124 of the mobile device 112 of the user 116 may display an error message. In some examples, if the user 106 who created the media object 102 and/or uploaded the media object 102 to the media repository 108 has indicated that the media object 102 may be viewed by the general public, then any user may designate the media object 102 to be received by any other user. In some examples, the user 106 who created the media object 102 and/or uploaded the media object 102 to the media repository 108 may change the users who are designated to receive the media object 102. For example, if the user 106 removes a user 116 from a list of users authorized to receive and access (e.g., view or playback), the media object 102 will be removed from the mobile device 112 of the user. This technique in which a user designates a media object 102 for removal is sometimes referred to as “unsharing.” For example, the media object 102 may be removed from the mobile device 112 after the media repository 108 issues an instruction to the mobile device 112 to remove the media object 102. In some examples, when a mobile device 112 is instructed to remove the media object 102, the mobile device 112 is caused to remove data related to the media object 102 from storage (for example, non-volatile storage, temporary storage such as a cache, or other storage) associated with the mobile device 112. For example, the mobile device 112 may store information describing the media object 102 such as metadata related to the media object 102. This information can be removed from storage when a media object 102 is unshared. A wide variety of other arrangements can be provided to enable users to control the delivery of media objects to other users and to exclude the delivery of the media objects to other users.

In some implementations, the media repository 108 delivers content to the mobile devices 100, 112, 114 based on a payment plan. In some examples, the users 106, 116, 118 may be able to transmit or receive a certain number of media objects for free (e.g., without providing payment). For example, a user 106 who has not submitted payment may be limited to transmitting or receiving fifty media objects 102 within a certain time period, for example, in a calendar month or a 30-day period. If the user 106 pays a monthly rate to an entity that operates the media repository 108, the user can be enabled to upload or download more media objects 102. In some examples, multiple monthly rates are each associated with a quantity of media objects 102. For example, in a given month, the user may upload or download fifty media objects 102 for free, and one hundred media objects for a first monthly rate (e.g., $1/month), and two hundred media objects 102 for a second monthly rate (e.g., $5/month). In some examples, the media repository 108 places a limit on media object data, along with or in place of the limit on a number of media objects 102. For example, in a given month, the user may upload or download fifty megabytes of media object data for free, and one hundred megabytes of media object data for a first monthly rate (e.g., $1/month), and one gigabyte of media object data for a second monthly rate (e.g., $5/month). In some implementations, a user 106 of a mobile device 100 can use the user interface 120 of the mobile device 100 to submit payment to the media repository 108 or another entity.

In some implementations, the media objects are videos or audio files or other media objects having a length of time. In some examples, the user may upload media objects up to a certain length (e.g., five minutes) for free, and the user may upload media objects up to another length (e.g., thirty minutes) for a monthly rate (e.g., $5/month).

FIGS. 2A through 2D show an example user interface 200. For example, this user interface 200 could be a view of the user interface 120, 124 of one of the mobile devices 100, 112, 114 shown in FIG. 1. In this example, the user interface 200 displays icons or thumbnails or other indications of media objects that are video files available for playback. The user interface 200 includes a my videos button 202, a received videos button 204, and a find more videos button 206.

The my videos button 202, when invoked, allows a user of the user interface 200 to view thumbnails 214, 216, 218 of videos that can be accessed. For example, a user can click on the video thumbnails 214, 216, 218 using an input device or tap on the video thumbnails 214, 216, 218 if the user interface 200 is displayed on a touchscreen of a mobile device. In some examples, a video corresponding to the video thumbnail 214, 216, 218 is then played. In some examples, more information about the video corresponding to the video thumbnail 214, 216, 218 is displayed. In some examples, the user selects one of the video thumbnails 214, 216, 218 in one action and then plays the selected video thumbnail 214, 216, 218 in a second action. For example, the user can invoke a play button 212 of the user interface 200 to play the video represented by the video thumbnail 214, 216, 218. In some implementations, the videos represented by the video thumbnails 214, 216, 218 are videos recorded by a user of the user interface 200 (e.g., a user 106 of the mobile device 100 that generates the media object 102 shown in FIG. 1).

The video thumbnails 214, 216, 218 are displayed in a thumbnail portion 208 of the user interface 200. If the user clicks (or taps or otherwise invokes) the received videos button 204, then the thumbnail portion 208 of the user interface 200 will change to displaying thumbnails of videos that have been received from other users. For example, the videos displayed when the received videos button 204 is pressed could be videos transmitted by a user to a media repository (e.g., the media repository 108 shown in FIG. 1) and then delivered to the mobile device displaying the user interface 200.

If the user clicks (or taps) on the find more videos button 206, then the thumbnail portion 208 of the user interface 200 will change to a search engine interface that allows a user of the user interface 200 to search for other videos. In some examples, the user may enter text to search for videos having content responsive to the text. For example, the user may search for videos based on keywords associated with the videos. In some examples, the user may be searching for videos transmitted by a particular other user or users.

The user interface 200 also has a record button 210 that allows a user of the user interface 200 to record a new video. For example, the user can invoke the record button 210 to activate a camera of the mobile device displaying the user interface 200. The new video, once recorded, will appear among the video thumbnails 214, 216, 218. The new video can also be transmitted to a media repository (e.g., the media repository 108 shown in FIG. 1) immediately after it is recorded, for example, or another time after it has been recorded based on conditions of the mobile device on which the user interface operates or at another time determined by the mobile device.

As shown in FIG. 2B, a user of the user interface 200 can select one of the video thumbnails 216 (shown highlighted by a box around the thumbnail). For example, the user can play back the video represented by the selected video thumbnail 216. As another example, the user can view information about the video represented by the selected video thumbnail 216 and indicate other users to receive the video represented by the selected video thumbnail 216.

FIG. 2C shows the user interface 200 displaying more information about the video 220 represented by the video thumbnail 216. In some examples, the information can include a title and description 222 of the video 220. For example, a user who created the video 220 may have written the title and description 222. In some examples, the information can include a recipient list 224 of the video 220. The recipient list 224 shows the names of users who have received the video 220 or are otherwise authorized to access the video. For example, a recipient of the recipient list 224 may be authorized to access the video but has not yet received the view, for example, if the recipient's mobile device has not yet downloaded the video. In some implementations, the recipient list 224 may indicate which recipients have not yet downloaded the video or viewed the video. For example, recipients of the recipient list 224 could be indicated in different ways with different flags or icons or other visual indicators. The recipient list 224 may have been generated by a user of the user interface 200 or the recipient list 224 may have been generated by the user who created or uploaded the video 220 or the recipient list 224 may have been generated by another user. Further, any one of these kinds of users may have added additional names to the recipient list 224. For example, the user who created or uploaded the video 220 may have added some names to the recipient list 224 while a user who received the video 220 may have added additional names to the recipient list 224.

The recipient list 224 includes a share with friends button 226 and a share with everyone button 228. When invoked, the share with friends button 226 allows the user of the user interface 200 to indicate particular users who may receive the video 220. For example, the user interface 200 can display a list of names known to the user (e.g., a contact list available on the user's mobile phone or available on a social networking service used by the user). The user can then select names for whom the video 220 will be delivered. If additional recipients have been added to the recipient list 224 by a user other than the user who generated the video 220, the user who generated the video 220 will see the additional recipients when he views the recipient list 224.

When invoked, the share with everyone button 228 allows the user of the user interface 200 to indicate that anyone may receive the video 220. For example, the share with everyone button 228 may enable the video 220 to appear in a search of public videos (e.g., using the functionality of the find more videos 206 button). The video 220 may be delivered to other users when the share with everyone button 228 is invoked, or the video 220 may be authorized for later delivery to other users who proactively seek the video 220 at a later time. In some examples, some users may be presented with a list of videos 220 which they are authorized to receive, and can select which videos 220 to download to their respective mobile devices. In some examples, the video 220 may appear in search engine results sought by a user, and the user can select the video 220 for download within the search engine results.

FIG. 2D shows a video 232 being recorded in the user interface 200. In this example, a user has invoked the record button 210 to active a camera of the mobile device displaying the user interface 200. The user interface 200 shows the point of view 230 of the camera lens so that the user of the user interface 200 can see what is being recorded. The video 232 will then be available to be delivered to other users as well as being available for playback in the user interface 200. The user can invoke the record button 210 a second time to stop recording. In some examples, when the user has recorded the video 232, the user interface 200 presents the user with options for whom the video 232 should be delivered to. For example, the user can make the video 232 public (available to anyone), or, for example, the user can indicate particular users who may receive the video 232, e.g, in the form of a recipient list 224. In some examples, the user can indicate that other recipients can be added to the recipient list 224 at a later time by other users.

The video 232 can then be delivered to the indicated recipients at a time determined by the mobile device on which the user interface 200 operates, without further control by or feedback to the user of the user interface 200. In some examples, the user interface 200 provides a list of possible recipients to the user, and the user can indicate that the video 232 is to be delivered to all of the possible recipients. The user's selection of recipients is optional.

FIG. 3A shows an example of a user interface 300 of a mobile device. For example, this user interface 300 could be a view of the user interface 120, 124 of one of the mobile devices 100, 112, 114 shown in FIG. 1. This user interface 300 has a my videos button 202, a received videos button 204, a find more videos button 206, a record button 210, and a play button 212. In this example, the thumbnail portion 208 of the user interface 300 shows a video thumbnail 216 that was shown in the user interface 200 shown in FIG. 2A. For example, the mobile device displaying the first user interface 200 may have transmitted the video represented by the video thumbnail 216 for viewing by a user of this user interface 300. The user interface also displays the title and description 222 and a recipient list 224 of the video represented by the video thumbnail 216. In addition to a share with friends button 226 and a share with everyone button 228, the user interface 300 also has a delete button 240. When invoked, the delete button 240 will remove the video represented by the selected video thumbnail 216 from the thumbnail portion 208 of the user interface 300 and delete the video represented by the selected video thumbnail 216 from the mobile device displaying the user interface 300.

As shown in FIG. 3B, a user of the user interface 300 has invoked the record button 210 to display the point of view 230 of the camera lens. The user of the user interface 200 can then see a video 332 that is being recorded. The video 332 will then be available to be delivered to other users as well as being available for playback in the user interface 300. The user can invoke the record button 210 a second time to stop recording.

FIG. 3C shows an example user interface 350 for “following” other users of a media repository. For example, the user interface 350 could be displayed on a mobile device 100 and the users could be the users 106, 116, 118 of the media repository 108 shown in FIG. 1. A user “follows” other users by choosing to receive videos transmitted by other users, for example, transmitted by the other users to the media repository. When a user chooses to follow another user, videos transmitted by the other user can be subsequently automatically delivered to the user's mobile device. For example, when a user chooses to follow another user, the user can play videos previously transmitted by the other user and also later play videos transmitted by the user when the newly transmitted videos become available.

As shown in FIG. 3C, the user interface 350 includes a catalog 355 of users 352, 354 who can be followed. A user can be followed if the user has publically shared any of his videos (or other media objects). When a user of the user interface 350 accesses the catalog 355, the user can select users 352, 354 to follow. For example, the user can tap or click or otherwise select the name of any of the users 352, 354 and then select a follow button 358 available in the user interface 350. The users 352, 354 will then be added to a list of followed users associated with the user of the user interface 350. For example, the list of followed users could be stored on the mobile device, or the list of followed users could be stored on a user account available to the mobile device, for example, a user account stored at the media repository 108. The user interface 350 may also have other buttons 356, for example, a button for requesting more details about a user 352, 354 in the catalog 355, or a button for blocking a user 352, 354 in the catalog from receiving videos transmitted by a user of the user interface 350.

As shown in FIG. 3D, the user interface 350 can also display a feed 360 of videos 360, 362 uploaded by users followed by the user of the user interface 350. The videos 360, 362 are represented in the feed 364 by the names of the respective users who uploaded the videos 360, 362 as well as the respective times at which the videos were uploaded. The user of the user interface 350 can select any of the videos 360, 362 in the feed 364 to play the video. When a user followed by the user of the user interface 350 uploads a new video, the video automatically appears in the feed 364. For example, the most recently uploaded video can appear as the first video in the feed 364 (e.g., at the top of the feed 364 as it is displayed in the user interface 350).

In some implementations, a first user can choose a second user to receive videos uploaded by the first user. For example, referring to FIG. 1, a first user 106 can designate that videos he uploads will be delivered to a second user 116. The first user 106 then becomes a user followed by the second user 116. In some examples, the videos uploaded by the first user 106 will then appear in the feed 364 of followed users shown in FIG. 3D, e.g., as displayed on a mobile device of the second user 116. In some examples, when the first user 106 designate that the videos he uploads will be delivered to a second user 116, the second user 116 can accept or reject the action of the first user 106. For example, if the second user 116 does not wish videos of the first user 106 to appear in his feed 364, the second user 116 can choose not to accept the first user 106 as a followed user. In some examples, the user interface 350 offers a user the choice of accepting or rejecting the addition of another user to the user's list of followed users, for example, in the form of “accept” or “reject” buttons displayed on the user interface.

Referring to FIG. 1, a mobile device 100 has limited capacity to store media objects 102 such as videos. For example, the mobile device 100 has data storage (e.g., solid state memory or flash memory or other kinds of storage) of finite capacity. In some examples, the mobile device 100 may have a designated amount of storage space allocated to media objects 102 such that media object data cannot exceed the designated amount of storage. The mobile device 100 can remove media objects that it received, such as videos, according to various criteria. In some examples, the mobile device 100 removes videos received least recently. For example, referring to FIG. 3D, the oldest video 362 represented in the feed 364 can be removed when the allocated storage capacity of the corresponding mobile device has been reached. In some examples, a video 362 represented in the feed 364 can be removed when the user has viewed the video 362. In some examples, the representation of the video 362 in the feed 364 may be removed when the underlying video 362 is deleted from the mobile device. In some examples, the representation of the video 362 remains in the feed 364 when the underlying video 362 is deleted from the mobile device. In some implementations, if a user of the mobile device selects the video 362 in the feed 364 after the video 362 has been deleted, the mobile device can download the video 362 or stream the video 362 for display on the user interface of the mobile device. In some implementations, a user can indicate that a particular video 362 be deleted, for example, by selecting the video 362 and selecting a “delete” button in the user interface 350. In some implementations, a user can indicate that a particular video 360 not be deleted (e.g., retained in storage of the mobile device), for example, by selecting the video 362 and selecting a “retain” button in the user interface 350.

FIG. 4 shows a flowchart of an example process 400 that can be used to generate and upload a media object. For example, a mobile device 100 shown in FIG. 1 could carry out the operations described here to upload a media object 102 to a media repository 108. The mobile device generates the media object (402). For example, a user of the mobile device can invoke record functionality to record a video using a camera of the mobile device. Once the media object has been generated (e.g., recorded and generated), the mobile device prompts a user of the mobile device for recipients of the media object (404). The user can indicate particular recipients, or the user can indicate that all individuals known to the user (e.g., a contact list maintained by the user) are recipients of the media object, or the user can indicate that the media object may be shared with the public, e.g., available on a search engine that returns media objects responsive to search terms. The user may indicate that only the designated recipients may receive the media object, for example, or the user may indicate that recipients of the media object may share the media object with further recipients, who may or may not be known to the original user who generates the media object. The mobile device then uploads the media object to the media repository (406). The user of the mobile device may not even be aware of or control the uploading of the media object.

FIG. 5 shows an example of a computing device 500 and a mobile device 550, which may be used with the techniques described here. For example, referring to FIG. 1, the mobile devices 100, 112, 114 could be examples of the computing device 500 or the mobile device 500, and the media repository 108 could include one or more computer devices 500. Computing device 500 is intended to represent various forms of digital computers, such as laptops, desktops, workstations, personal digital assistants, servers, blade servers, mainframes, and other appropriate computers. Computing device 550 is intended to represent various forms of mobile devices, such as personal digital assistants, cellular telephones, smartphones, and other similar computing devices. The components shown here, their connections and relationships, and their functions, are meant to be examples only, and are not meant to limit implementations of the techniques described and/or claimed in this document.

Computing device 500 includes a processor 502, memory 504, a storage device 506, a high-speed interface 508 connecting to memory 504 and high-speed expansion ports 510, and a low speed interface 512 connecting to low speed bus 514 and storage device 506. Each of the components 502, 504, 506, 508, 510, and 512, are interconnected using various busses, and may be mounted on a common motherboard or in other manners as appropriate. The processor 502 can process instructions for execution within the computing device 500, including instructions stored in the memory 504 or on the storage device 506 to display graphical information for a GUI on an external input/output device, such as display 516 coupled to high speed interface 508. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 504 stores information within the computing device 500. In one implementation, the memory 504 is a volatile memory unit or units. In another implementation, the memory 504 is a non-volatile memory unit or units. The memory 504 may also be another form of computer-readable medium, such as a magnetic or optical disk.

The storage device 506 is capable of providing mass storage for the computing device 500. In one implementation, the storage device 506 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 504, the storage device 506, memory on processor 502, or a propagated signal.

The high speed controller 508 manages bandwidth-intensive operations for the computing device 500, while the low speed controller 512 manages lower bandwidth-intensive operations. Such allocation of functions is an example only. In one implementation, the high-speed controller 508 is coupled to memory 504, display 516 (e.g., through a graphics processor or accelerator), and to high-speed expansion ports 510, which may accept various expansion cards (not shown). In the implementation, low-speed controller 512 is coupled to storage device 506 and low-speed expansion port 514. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 520, or multiple times in a group of such servers. It may also be implemented as part of a rack server system 524. In addition, it may be implemented in a personal computer such as a laptop computer 522. Alternatively, components from computing device 500 may be combined with other components in a mobile device (not shown), such as device 550. Each of such devices may contain one or more of computing device 500, 550, and an entire system may be made up of multiple computing devices 500, 550 communicating with each other.

Computing device 550 includes a processor 552, memory 564, an input/output device such as a display 554, a communication interface 566, and a transceiver 568, among other components. The device 550 may also be provided with a storage device, such as a microdrive or other device, to provide additional storage. Each of the components 550, 552, 564, 554, 566, and 568, are interconnected using various buses, and several of the components may be mounted on a common motherboard or in other manners as appropriate.

The processor 552 can execute instructions within the computing device 550, including instructions stored in the memory 564. The processor may be implemented as a chipset of chips that include separate and multiple analog and digital processors. The processor may provide, for example, for coordination of the other components of the device 550, such as control of user interfaces, applications run by device 550, and wireless communication by device 550.

Processor 552 may communicate with a user through control interface 558 and display interface 556 coupled to a display 554. The display 554 may be, for example, a TFT LCD (Thin-Film-Transistor Liquid Crystal Display) or an OLED (Organic Light Emitting Diode) display, or other appropriate display technology. The display interface 556 may comprise appropriate circuitry for driving the display 554 to present graphical and other information to a user. The control interface 558 may receive commands from a user and convert them for submission to the processor 552. In addition, an external interface 562 may be provide in communication with processor 552, so as to enable near area communication of device 550 with other devices. External interface 562 may provide, for example, for wired communication in some implementations, or for wireless communication in other implementations, and multiple interfaces may also be used.

The memory 564 stores information within the computing device 550. The memory 564 can be implemented as one or more of a computer-readable medium or media, a volatile memory unit or units, or a non-volatile memory unit or units. Expansion memory 574 may also be provided and connected to device 550 through expansion interface 572, which may include, for example, a SIMM (Single In Line Memory Module) card interface. Such expansion memory 574 may provide extra storage space for device 550, or may also store applications or other information for device 550. Specifically, expansion memory 574 may include instructions to carry out or supplement the processes described above, and may include secure information also. Thus, for example, expansion memory 574 may be provide as a security module for device 550, and may be programmed with instructions that permit secure use of device 550. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 564, expansion memory 574, memory on processor 552, or a propagated signal that may be received, for example, over transceiver 568 or external interface 562.

Device 550 may communicate wirelessly through communication interface 566, which may include digital signal processing circuitry where necessary. Communication interface 566 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 568. In addition, short-range communication may occur, such as using a Bluetooth, WiFi, or other such transceiver (not shown). In addition, GPS (Global Positioning System) receiver module 570 may provide additional navigation- and location-related wireless data to device 550, which may be used as appropriate by applications running on device 550.

Device 550 may also communicate audibly using audio codec 560, which may receive spoken information from a user and convert it to usable digital information. Audio codec 560 may likewise generate audible sound for a user, such as through a speaker, e.g., in a handset of device 550. Such sound may include sound from voice telephone calls, may include recorded sound (e.g., voice messages, music files, and so forth) and may also include sound generated by applications operating on device 550.

The computing device 550 may be implemented in a number of different forms, as shown in the figure. For example, it may be implemented as a cellular telephone 580. It may also be implemented as part of a smartphone 582, personal digital assistant, tablet computer, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well. For example, feedback provided to the user can be any form of sensory feedback (e.g., visual feedback, auditory feedback, or tactile feedback). Input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

Other implementations are also within the scope of the following claims.

What is claimed is:

1. A method comprising
from a wireless handheld device, automatically transferring to another location a media object captured on the wireless handheld device, without requiring a user of the wireless handheld device to initiate the transfer of the media object, and
regulating the transfer in response to information about a condition of the wireless handheld device.

2. The method of claim 1 in which the condition comprises a charge level of a battery of the wireless handheld device.

3. The method of claim 1 in which the condition comprises a quality of a network connection which carries the transfer of the media object.

4. The method of claim 1 in which the condition comprises available storage space on the wireless handheld device.

5. The method of claim 1 in which regulating the transfer comprises changing a speed of the transfer.

6. The method of claim 1 in which regulating the transfer comprises determining a start time of the transfer based on the conditions.

7. The method of claim 1 in which regulating the transfer comprises pausing the transfer at a first time and resuming the transfer at a second time after the first time.

8. The method of claim 1 in which the information about the condition is acquired by monitoring the condition at the wireless handheld device.

9. The method of claim 1 in which the media object comprises a video.

10. The method of claim 1 in which the media object comprises an image.

11. The method of claim 1 in which the other location comprises a storage facility distributed on a network.

12. The method of claim 1 in which the other location comprises a web site storing videos and offering the videos for viewing.

13. The method of claim 1 in which the handheld wireless device comprises a mobile phone.

14. The method of claim 1 in which the handheld wireless device comprises a tablet computer.

15. The method of claim 1 comprising accepting settings from the user which control the transfer of the media object.

16. The method of claim 1 comprising at the wireless handheld device, accepting from the user an indication of one or more recipients for the media object.

17. The method of claim 1 comprising displaying on the wireless handheld device information about recipients of the media object.

18. The method of claim 17 comprising accepting from the user an indication of names to be removed from a list of names of the recipients.

19. The method of claim 1 comprising displaying information about activities of at least some recipients of the media object, the activities pertaining to the media object.

20. The method of claim 1 comprising at the wireless handheld device, accepting from the user an indication of no restrictions on who may receive the media object.

21. The method of claim 1 comprising transferring the media object from the wireless handheld device based on a condition of the wireless handheld device.

22. The method of claim 21 in which conditions of the wireless handheld device comprise remaining battery life of the wireless handheld device.

23. The method of claim 21 in which conditions of the wireless handheld device comprise a communications network available to the wireless handheld device.

24. A method comprising
at a wireless handheld device, automatically receiving from another location a media object captured on another wireless handheld device without requiring a user of the wireless handheld device to initiate the receipt of the media object, and
regulating the receipt in response to information about a condition of the wireless handheld device.

25. The method of claim 24 in which the condition comprises a charge level of a battery of the wireless handheld device.

26. The method of claim 24 in which the condition comprises a quality of a network connection which carries the media object undergoing receipt.

27. The method of claim 24 in which the condition comprises available storage space on the wireless handheld device.

28. The method of claim 24 in which regulating the receipt comprises changing a speed of the receipt.

29. The method of claim 24 in which regulating the receipt comprises determining a start time of the receipt based on the conditions.

30. The method of claim 24 in which regulating the receipt comprises pausing the receipt at a first time and resuming the receipt at a second time after the first time.

31. The method of claim 24 in which the information about the condition is acquired by monitoring the condition at the wireless handheld device.

32. The method of claim 24 in which the media object comprises a video.

33. The method of claim 24 in which the media object comprises an image.

34. The method of claim 24 in which the other location comprises a storage facility distributed on a network.

35. The method of claim 24 in which the other location comprises a web site storing videos and offering the videos for viewing.

36. The method of claim 24 in which the handheld wireless device comprises a mobile phone.

37. The method of claim 24 in which the handheld wireless device comprises a tablet computer.

38. The method of claim 24 comprising, at the wireless handheld device, accepting settings from the user prior to the receipt.

39. The method of claim 24 in which the user is identified as a recipient of the media object by a user of another handheld wireless device.

40. The method of claim 24 in which the media object has been designated as having no restrictions on who may receive the media object.

41. The method of claim 24 comprising downloading the media object to the wireless handheld device at a time based on a condition of the wireless handheld device.

42. The method of claim 41 in which conditions of the wireless handheld device comprises remaining battery life of the wireless handheld device.

43. The method of claim 41 in which conditions of the wireless handheld device comprises a communications network available to the wireless handheld device.

44. A method comprising
on behalf of a user of a wireless handheld device, maintaining settings to control automatic uploading of videos captured at the device and automatic downloading of the videos to other target wireless handheld devices.

45. The method of claim 44 in which the control settings identify the target wireless handheld devices.

46. The method of claim 44 in which the control settings specify conditions under which the video is to be uploaded.

47. A method comprising
upon generation of a video by a wireless handheld device, prompting a user of the handheld device to identify recipients for the video, and
through a network, communicating information about the video to the identified recipients, the information including data usable to access the video at other wireless handheld devices each possessed by one of the respective identified recipients.

48. The method of claim 47, comprising receiving from the user of the handheld device an indication of the extent to which the information about the video may be transmitted to entities other than the identified recipients.

49. The method of claim 47, in which prompting a user of the handheld device for identities of recipients of the video comprises providing identification information about possible recipients to the user, and subsequently receiving from the user of the handheld device an indication that the information about the video is to be transmitted to all of the possible recipients.

50. The method of claim 47 comprising, through the network, subsequently communicating information indicating that the access to the video be disabled at the other wireless handheld devices.

51. A method comprising
on a first wireless handheld device:
receiving from a user of a second wireless handheld device information describing a video stored on a remote server, the information usable to access the video, and
absent user input within a user interface, displaying a graphical element representing the video, the graphical element displayed among other graphical elements representing other videos.

52. The method of claim 51 comprising receiving authorization that information may be received from the user of the second wireless handheld device.

53. The method of claim 51 in which the graphical elements are displayed in a chronological order of receipt of the videos.

54. The method of claim 51 in which the graphical element is displayed among other graphical elements representing other videos received from other users.

55. The method of claim 51 in which the graphical element comprises an identification of the user of the second wireless handheld device.

56. The method of claim 51 in which the user of the second wireless handheld device is designated on a list of users of wireless handheld devices authorized by a user of the wireless handheld device to deliver videos to the first wireless handheld device.

57. The method of claim 56 comprising
receiving, from the user of the second wireless handheld device, a request to add the user of the second wireless handheld device to the list of users of wireless handheld devices.

58. The method of claim 56 comprising
receiving, from the user of the first wireless handheld device, a request to add the user of the second wireless handheld device to the list of users of wireless handheld devices.

59. The method of claim 51 comprising
deleting the video from the first wireless handheld device based on a chronological age of the video relative to other videos received at the first wireless handheld device.

60. The method of claim 51 comprising
deleting the video from the first wireless handheld device subsequent to an indication by a user of the first wireless handheld device to view the video.

61. The method of claim 51 comprising
deleting the video from the first wireless handheld device based on a limit of data storage allocated to videos on the first wireless handheld device.

62. A method comprising
on a first wireless handheld device:
displaying a list of users of wireless handheld devices who publically share at least one video, the list received from a storage facility distributed on a network
receiving, on a user interface of the first wireless handheld device, from a user of the first wireless handheld device, an indication to add at least one of the users of wireless handheld devices to a list of users of wireless handheld devices authorized to deliver videos to the first wireless handheld device.

63. A method comprising
on a wireless handheld device:
receiving information describing a video stored on a remote server, the information usable to access the video,
receiving, from a user of the handheld device, information identifying recipients of the video, and
through a network, communicating the information usable to access the video to the identified recipients.

64. The method of claim 63 in which communicating the information usable to access the video to the identified recipients comprises communicating information identifying the user of the handheld device to the identified recipients.

65. A handheld wireless device comprising:
a user interface enabling a user of the handheld wireless device to
record a video using the handheld wireless device,
designate one or more users of other wireless devices who are to be recipients of the video, and
define conditions for uploading of the video for delivery to the recipients.

66. The handheld wireless device of claim 65 wherein the user interface enables a user to designate a video for unsharing, wherein unsharing comprises sending a directive to the devices of the recipients which causes those devices to remove data related to the video from storage associated with the devices of the recipients.

67. The handheld wireless device of claim 65 wherein the user interface displays a plurality of graphical elements, each representing a video available for playback.

68. A method comprising
at a storage facility distributed on a network, receiving, from a wireless handheld device, a media object captured on the wireless handheld device, without requiring a user of the device to initiate the delivery of the media object and without requiring the user to control the delivery of the media object.

69. The method of claim 68 comprising sending the media object to another wireless handheld device, without requiring a user of the other wireless handheld device to initiate the receipt of the media object and without requiring the user of the other wireless handheld device to control the receipt of the media object.

70. A method comprising
at a storage facility distributed on a network, sending, to a first wireless handheld device, a media object captured on a second wireless handheld device, without requiring a user of the first wireless handheld device to initiate the receipt of the media object and without requiring the user to control the receipt of the media object.

71. A method comprising:
automatically providing media objects to a wireless handheld device without requiring a user of the wireless handheld device to initiate or to control receipt of the media objects, the number of received media objects and quantity of received media object data being limited within a time period,
wherein a first number of media objects and a first quantity of media object data are automatically provided within the time period for free, and a second number of media objects and a second quantity of media object data are automatically provided within the time period at a monthly rate of payment.

72. The method of claim 71 comprising receiving payment information from the wireless handheld device and providing a number of media objects greater than the first number of media objects to the wireless handheld device within the time period.

73. The method of claim 71 comprising receiving payment information from the wireless handheld device and providing a quantity of media object data greater than the first quantity of media object data to the wireless handheld device within the time period.

74. A method comprising:
accepting media objects from a wireless handheld device without requiring a user of the wireless handheld device to initiate or to control transfer of the media objects, the quantity of media object data of each media object being limited within a time period,
wherein media objects having a first quantity of media object data are accepted within the time period for free, objects having a second quantity of media object data are accepted within the time period at a monthly rate of payment, the second quantity being larger than the first quantity.

75. The method of claim 74 in which the first quantity of media object data comprises a first length of time of the corresponding media object and the second quantity of media object data comprises a second length of time of the corresponding media object.

76. A method comprising
at a target handheld wireless device, automatically receiving, through a server from a source handheld wireless device, a video file that was captured by a camera at the source handheld wireless device,
the receipt of the video file at the target handheld wireless device occurring without a user of the target device initiating the receipt, the identity of the target handheld device having been specified by a user of the source handheld device.
